(19) United States
(12) Patent Application Publication
(10) Pub. No.: US 2013/0054281 A1
(43) Pub. Date: Feb. 28, 2013

(54) METHODS AND SYSTEMS FOR RIDESHARE

(71) Applicants: Sohil Thakkar, North Andover, MA (US); Amit Vasani, Scotch Plains, NJ (US); Wai Fan Cheng, Melrose, MA (US)

(72) Inventors: Sohil Thakkar, North Andover, MA (US); Amit Vasani, Scotch Plains, NJ (US); Wai Fan Cheng, Melrose, MA (US)

(73) Assignee: GreenMiles Technologies LLC

(21) Appl. No.: 13/595,579

(22) Filed: Aug. 27, 2012

Related U.S. Application Data
(60) Provisional application No. 61/528,247, filed on Aug. 28, 2011.

(51) Int. Cl. G06Q 50/30

(52) U.S. Cl. 705/5

(57) ABSTRACT

This disclosure relates to a method, article of manufacture, and apparatus for rideshare. In some embodiments, this includes receiving at least one participant data, at least one vehicle data, and at least one trip interest, wherein each of the one participant data comprises a personal communication device identifier associated with a personal communication device, forming a contract for a rideshare trip among participants, wherein the contract includes trip cost payment terms and alternative transportation cost payment terms in case of a plurality of contract transactions, monitoring from a rideshare platform a performance of the rideshare trip, based on the performance, calculating costs associated with the rideshare trip and determining contract transactions according to the contract, performing the contract transactions, and allocating carbon credits in the rideshare trip.

### CROSS-REFERENCE TO RELATED APPLICATIONS

This application claims the benefit of U.S. Provisional Patent Application No. 61/528,247, filed on Aug. 28, 2011, entitled Methods and Systems for Financial and Carbon Transactions in A Rideshare System, which is herein incorporated by reference in its entirety.

### FIELD

The present invention relates generally to ridesharing in a transportation system and specifically to a system and method for utilizing contracts in an efficient and cost effective rideshare system in order to bring more social and quantifiable benefits to participants and the environment respectively.

### BACKGROUND

Road congestion has dramatically increased as more and more vehicles vie for space on the road. Although there is effort of bringing in more fuel efficient and cleaner running vehicles, the increasing number of vehicles taken to the roads may outweigh such effort. Researches have shown that the increasing amount of fuel burning carbon emission may have contributed to the greenhouse effect of global warming. To easy road congestion and to reduce the greenhouse effect, many rideshare systems have been proposed by various entities, including academia, governments and corporations, to encourage people to rideshare.

For example, one form of ridesharing often promoted by governments and/or corporations is public transportation, such as riding a bus. Although a bus may produce more carbon emission than a car, a bus may serve the purpose of reducing the greenhouse effect by transporting many more people than a car. However, to many passengers, ridesharing on a bus does not provide flexibility in terms of the travel routes and the rides time. In addition, under conventional approaches, merely based on the number of passengers taking bus ride, it is unclear whether the rideshare actually reduces carbon emission. Conventional methods and systems may not have enough information such as the road conditional affecting each trip, the carbon emission information of each passenger's alternative choice transportation etc. to accurately calculate social and environmental benefits.

Another form of ridesharing is carpooling. Relative to riding a bus, carpooling is more flexible. A group of people may take turns driving from a departure point to a destination point in a single vehicle. This way, the number of cars on the road may be reduced. Consequently, the amount of fuel burned and exhaust emitted may also be reduced. However, to realize cost savings while preserving the flexibility, advance planning of carpooling is required. In particular, large scale carpooling planning often involves planning among unrelated potential participants with different origin, destination, time, and budget concerns. Significant amount of coordination effort among interested rideshare participants is necessary.

To facilitate the complex planning of rideshare, some conventional rideshare methods and systems take advantage of technologies such as wireless communication and internet to match ridesharing parties, departure and destination locations, and time etc. In such conventional methods and systems, some incentives may be built in to encourage rideshare and help rideshare participants realize rideshare cost savings. However, such conventional rideshare methods and systems often fall short in several aspects.

First, one selling point of rideshare is the benefit to the environment. However, although conventional methods and systems in existence today may be augmented to measure carbon emission during a trip by mounting emission monitoring vehicle telemetric unit in ride share vehicles, the reduction of carbon emission as a result of rideshare is not measurable by such conventional methods and systems. In addition, requiring a dedicated device mounted in a vehicle for carbon emission measurements may be cost prohibitive for many rideshare participants. The potential high cost for rideshare equipment combined with inadequate measurements of carbon emission reduction and automatic co-occupancy verification and/or detection may be factors preventing conventional rideshare methods and systems from drawing in or retaining rideshare participants.

Second, another selling point of rideshare is the cost savings to participants yet preserving some degrees of flexibility. Many conventional rideshare methods and systems may not recognize that rideshare arrangement is a form of contract. On one hand, when a passenger agrees to rideshare with a driver, he or she expects that a driver will actually show up at an agreed location upon an agreed time and actually drives the passenger to the agreed destination. On the other hand, given uncertainty of individual schedules, in reality, flexibility needs to be preserved in a rideshare system.

Conventional rideshare methods and systems often fail to consider the actuality, only calculate presumed cost savings in advance of the actual rideshare. Without including factors such as failure to perform contract in the equation, in some cases, the additional costs such as arranging for alternative transportation may erase any presumed cost savings for rideshare participants. Thus, without efficient and accurate measurements of actual cost savings for participants, conventional rideshare methods and systems may not provide enough incentives in order to draw in or retain rideshare participants.

There is a need, therefore, for a flexible, efficient, and cost effective rideshare method or system to create more social and environmental benefits.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram of an exemplary rideshare system in accordance with some embodiments.

FIG. 2 is a diagram illustrating exemplary participant ride matching and contract sub-system within a rideshare system in accordance with some embodiments.

FIG. 3 is a diagram illustrating exemplary personal communication device trip data gathering and trip and contract monitoring sub-system within a rideshare system in accordance with some embodiments.

FIG. 4 is a diagram illustrating an exemplary revenue sub-system within a rideshare system in accordance with some embodiments.

FIG. 5 is a diagram illustrating an exemplary carbon emission allocation during a rideshare trip in accordance with some embodiments.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded, in whole or in part, through the use of a software development kit or toolkit that enables the creation and implementation of the present invention. In this specification, these implementations, or any other form that the invention may take, may be referred to as techniques. In general, the order of the steps of disclosed processes may be altered within the scope of the invention.

An embodiment of the invention will be described with reference to methods and systems for rideshare, but it should be understood that the principles of the invention are not limited to just rideshare. Rather, they are applicable to any transportation systems including, but not limited to, personal, commercial, and public transportation. Although terms such as personal automobile may be used by way of example of a vehicle travelling in a transportation system, the principles of the invention are not limited to any particular form of vehicle. Rather, they are equally applicable to any vehicle capable of transportation including, but not limited to, taxis, carpool vans, bus, subways, rails and vehicles travelling in air and/or water.

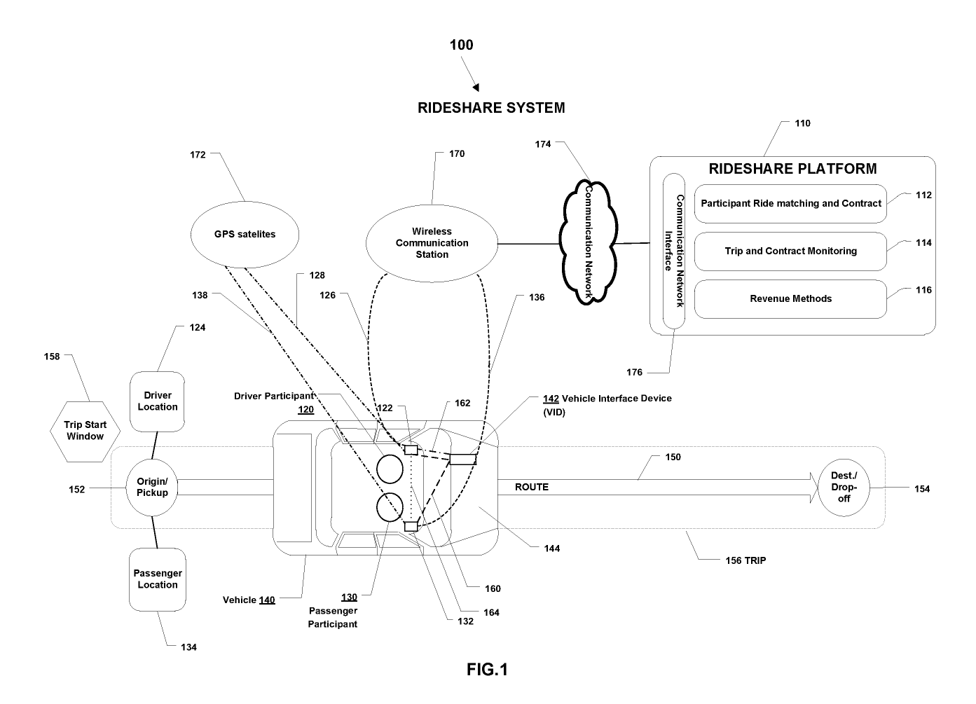

FIG. 1 illustrates an exemplary system for implementing the present invention, in accordance with some embodiments. Rideshare System 100 may include Rideshare Platform 110 communicating through Communication Network Interface 176 with various components during rideshare Trip 156. Through common communication interface provided by Common Network Interface 176, communication may be conducted over communication media such as Communication Network 174, Wireless Communication Station 170 and GPS satellites 172, among others. Though FIG. 1 illustrates Communication Network Interface 176 resides inside Rideshare Platform 110, Communication Network Interface 176 may reside internal or external to and operate or be operated inside or outside Rideshare Platform 110.

Wireless Communication Station 170 may be responsible for forming and relaying wireless communications within Rideshare System 100. Communication Network 174 may be implemented using protocols such as Transmission Control Protocol (TCP) and/or Internet Protocol (IP), well known in the relevant arts. In some embodiments, Communication Network 174 may be a dedicated communication link, one or more networks, a local area network, a wide area network, a storage area network, the Internet, a wired network, and/or wireless network, among others.

Rideshare Platform 110 may further include subsystems, such as Participant Ride Matching and Contract 112, Trip and Contract Monitoring 114, and Revenue Methods 116, among others. On Rideshare Platform 110, participants may be matched by Participant Ride Matching and Contract sub-system 112. After matching the participants, rideshare Trip 156 may be scheduled, and a contract may be formed. Trip and Contract Monitoring sub-system 114 may then monitor Trip 156 and enforce the agreed contract. Some contract transactions may be determined based on terms of the agreed contract. Revenue Methods sub-system 116 may be responsible for performing the contract transactions, deriving and collecting revenues for a Rideshare Platform 110 provider, and allocating carbon credits, among others.

Using Participant Ride Matching and Contract subsystem 112, a person, who wishes to share Vehicle 140 with another person for traveling along Route 150 may register with Rideshare Platform 110 as a participant. Participant Ride Matching and Contract 112 may then classify the participant as either Driver Participant 120 or Passenger Participant 130 based on the information received from the participants. Driver Participant 120 may agree to give ride to Passenger Participant 130 from Origin/Pickup location 152 to Destination/Drop-Off location 154 along Route 150, thereby making Trip 156 start within scheduled Trip Start Window 158.

After the initial registration with Rideshare Platform 110, Driver Participant 120 and Passenger Participant 130 may agree to meet at Origin/Pickup location 152. When they decide to meet up, Driver Location 124 and Passenger Locations 134 may be the same as Origin/Pickup location 152. Similarly, Driver Participant 120 and Passenger Participant 130 final destination may be the same as Destination/Drop-Off location 154. In some embodiments, Driver Location 124 and/or Passenger Locations 134 could be different from Origin/Pickup location 152. Though not illustrated in FIG. 1, Driver Participant 120 final destination and/or Passenger Participant 130 final destination may be different from Destination/Drop-Off location 154.

In some embodiments, Vehicle 140 used for transportation may be equipped with Vehicle Interface Device (VID) 142. VID 142 coupled with Vehicle 140 may be used as a bridge to communicate a generic communication device with Vehicle 140 engine control unit (ECU) and query data from ECU to determine vehicle information such as fuel consumption of Vehicle 140 during rideshare Trip 156. It may also be used to determine co-occupancy of Vehicle 140 during rideshare Trip 156.

An example of VID 142 may be Bluetooth-OBD-II interface adaptor. Bluetooth-OBD-II interface adaptor is an ODB-II connector that connects to Vehicle 140 OBD-II interface at one end and provides Bluetooth interface at the other end. In some embodiments, Bluetooth end of Bluetooth-ODB-II interface adaptor may be replaced with other short range technologies, such as WiFi or similar short range communication technologies. Embodiments described herein are described in the context of using the Bluetooth standard. Those of ordinary skill in the art will appreciate that Bluetooth is referred to herein as an example, and is not intended to limit the scope of the invention in any way.

OBD-II stands for On-Board Diagnostic-II. It is a standard for on-board diagnostic connectors. OBD-II standard specifies the type of diagnostic connector and its pinout, the signaling protocols available, and the messaging format for a vehicle's on-board diagnostic system. OBD-II standard has been adopted in on-board diagnostic system since the mid-90's and is well known in the art. Most vehicles built after 1996 provide interface for ODB-II connector to access various data from an ECU.

Once the Bluetooth-ODB-II interface adaptor is plugged into Vehicle 140 OBD-II interface, a generic communication device with Bluetooth radios may wirelessly read Vehicle Performance Data (VPD) 144. The communication may be conducted through wireless connections between the generic communication device and Bluetooth end of Bluetooth-ODB-II interface adaptor. Retail cost of such a generic communication reading device may be less than $20 US dollars at the time of this writing. VPD 144 retrieved from Vehicle 140 may include data that are needed to determine fuel consumption and/or distance travelled for Trip 156. For example, fuel type, fuel level and odometer reading at the start and the end of Trip 156 or vehicle speed, fuel trim, mass-air-flow ratio, and any other parameters needed to estimate actual fuel consumption and distance travelled may be included in VPD 144. Other data may be gathered to give state of vehicle, help improve vehicle performance, and/or find mechanical issues in Vehicle 140.

Though FIG. 1 illustrate VID 142 as an external device coupled to Vehicle 140 to query and access VPD, alternative techniques without using an external VID 142 may also be used by those of ordinary skill in the art. For example, it is possible for a vehicle manufacturer to provide wireless access via Bluetooth or similar technologies to communicate directly with Vehicle 140 ECU in order to read VPD 144. Further, though in some embodiments, only Bluetooth interface is provided at one end of Bluetooth-OBD-II interface adaptor, VID 142 may have multiple technologies interfaces. And software may be implemented to define multiple technologies radios in order to communicate with the multiple technologies interfaces of VID 142.

To participate in rideshare, each of the participants in rideshare Trip 156 may be equipped with a personal communication device (PCD) capable of long range wireless communication, short range wireless communication, and location determination. Each PCD may be associated with a PCD identifier. Recent mobile communication devices have been incorporating various technologies capable of operating in connection with Wireless Communication Station 170 for long range communication (i.e. 3G/4G/LTE smart phones), in connection with GPS Satellites 172 for location determination of the PCD, and in connection with other Bluetooth enabled devices for short range communication.

During Trip 156, Vehicle 140 may travel at a distance from Rideshare Platform 110. With PCD 122 in hand, Driver Participant 120 may communicate with Rideshare Platform 110 through Wireless Communication Station 170 via Long Range Wireless Connection 126. Similarly, Passenger Participant 130 may be equipped with PCD 132 that may make Long Range Wireless Connection 136 with Wireless Communication Station 170 in order to communicate with Rideshare Platform 110. Though FIG. 1 illustrates only one Wireless Communication Station 170, Rideshare System 100 may include more than one Wireless Communication Stations 170. PCD 122 and PCD 132 may be connected to the same Wireless Communication Station 170 or different Wireless Communication Stations 170 in order to communicate with Rideshare Platform 110.

Throughout Trip 156, PCD 122 and 132 may determine and record their respective locations 128 and 138 based on communications with/from Global Positioning System (GPS) Satellites 172. Though FIG. 1 illustrates only one set of GPS Satellites 172, PCD 122 and PCD 132 may be connected to the different sets of GPS Satellites 172 to make location determination. Further, GPS Satellites 172 may contain satellite systems deployed by various countries such as US, European Union, China, and Russia etc.

Within short range of Vehicle 140, PCD 122 and PCD 132 may make short range wireless communication with Vehicle 140. The short range wireless communication may be established first by determining the presence of VID 142. In some embodiments, standard Bluetooth discovery methods may be used to locate the presence of VID 142 using information such as VID 142 MAC address and/or Vehicle 140 VIN number. Alternative short range wireless communication techniques such as WiFi (BSSID as VID) may also be used by those of ordinary skill in the art.

Once the presence of VID 142 is determined, PCD 122 may initiate Bluetooth pairing and establish Communication Link 162 with VID 142 in order to access VPD 144 throughout Trip 156. Only authorized PCD 122 having pairing code may establish Communication Link 162 and query Vehicle 140 ECU to obtain VPD 144. Alternative short range wireless communication techniques such as WiFi may also be used by those of ordinary skill in the art. When WiFi is used, WiFi technology specific authentication mechanism (WEP, WPA/WPA-2 pre-shared key or 1x—with/without certificates etc.) may be used in place of the pairing code of Bluetooth technology for authentication. Similarly, Communication Link 160 may be established by passenger PCD 132 after authentication. Though FIG. 1 illustrates both Communication Link 160 and Communication Link 162, Communication Link 162 and Communication Link 160 may or may not be established and used at the same time for short range wireless communication with Vehicle 140.

In some embodiments, PCD 122 and PCD 132 may determine their proximities via standard Bluetooth Discovery Method 164 or similar short range wireless communication techniques used by those of ordinary skill in the art. Even without the presence of VID 142, utilizing location determination capability, PCD 122 and PCD 132 may determine and record their respective locations 128 and 138 based on communications with GPS Satellites 172. Combining the locations information and a positive result of Bluetooth Discovery Method 164, the presence of Driver Participant 120 and Passenger Participant 130 during a rideshare trip may be validated.

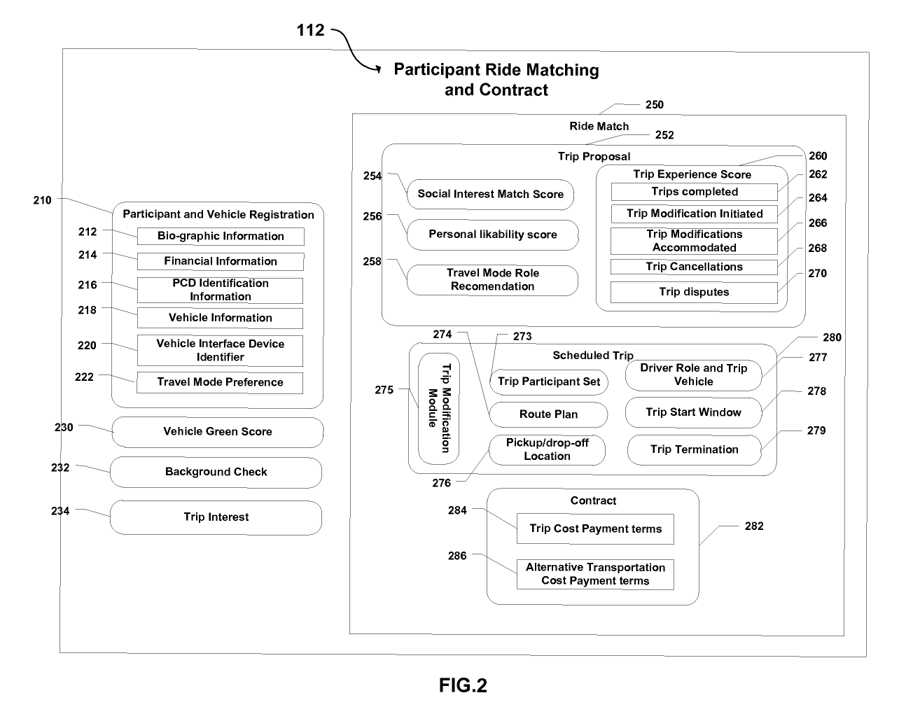

FIG. 2 further illustrates Participant Ride Matching and Contract sub-system 112 in accordance with some embodiments. Rideshare may begin with entering information into Participant and Vehicle Registration 210. Participant and Vehicle Registration 210 may be used to store information related to rideshare participants and vehicles. Trip planning information may also be entered into Trip Interest 234 to indicate participants' interest in sharing at least one vehicle for rideshare. The information received may be used by Ride Match 250 to match participants for rideshare trips.

Ride Match 250 may include stored information of Trip Proposal 252, Scheduled Trip 280, and Contract 282, among others. In some embodiments, Participant and Vehicle Registration 210, Trip Proposal 252, Scheduled Trip 280, and Contract 282 may be modules that are capable of executing the processes and methods described herein. As used herein, “module” may refer to logic embodied in hardware or firmware, or to a collection of instructions such as software instructions, possibly having entry and exit points, written in instructions or a programming language. The modules described herein may also be represented in hardware or firmware.

Participant and Vehicle Registration 210 may further include participant's Bio-graphic Information 212, Financial Information 214, PCD Identification Information 216, Vehicle Information 218, Vehicle Interface Device Identifier 220, and Travel Mode Preference 222, among others. PCD Identification Information 216 may be used to identify a PCD. For example, in some embodiments, PCD Identification Information 216 may be a cell number and/or a phone MEI number associated with a PCD.

Bio-graphic Information 212 may include any or all of the following information: name, address, age, social media handles and any other information that can be classified as such. Financial Information 214 may include any or all of: credit card or bank account for transaction purpose, earning and net worth and any other information that can be classified as such. Social media handles may be permission and/or access interfaces into a participant's social network account. For example, a participant with a Facebook account may allow modules such as Participant and Vehicle Registration 210 to access the Facebook profile and send invitation to the participant. With certain access privileges set implicitly or explicitly, the participant may use Facebook credential to authenticate to Participant and Vehicle Registration 210. Using participant's Bio-graphic Information 212, Background Check 232 may be performed to ensure the safety of rideshare participants.

Vehicle Information 218 may be information associated with a vehicle, including, but not limited to, VIN number, manufacturer, model and type, vehicle mileage in distance per unit fuel volume, and/or vehicle mileage profile specifying vehicle mileage at various vehicle speeds or driving condition such as city, highway etc. By default, a vehicle associated with Vehicle Information 218 may be considered a participant's alternate choice vehicle. That is, a vehicle the participant would use in absence of rideshare arrangement. A participant may provide one or more Vehicle Information 218 and mark one or more vehicles as alternate choice vehicles. If a participant does not own a vehicle, a hypothetical representative vehicle may be identified based on alternate mode of public transportation that may be used by participant to fill in Vehicle Information 218.

Vehicle Interface Device (VID) Identifier 220 may be used to identify a VID coupled to a vehicle. In some embodiments, VID Identifier 220 may include VID MAC address, serial number etc. In case of a manufacturer integrated device, VID Identifier 220 may also be a vehicle's VIN or an identifier derived from the vehicle's VIN. Travel Mode Preference 222 may be a preference for being a driver or a passenger or both for a rideshare trip, as well as maximum number of occupants in the rideshare trip that a participant wants to ride with.

Based on Participant and Vehicle Registration 210 data, Vehicle Green Score 230 may be calculated, and Background Check 212 may be performed. Vehicle Green Score 230 may represent how efficient a vehicle is. The more efficient a vehicle, such as higher miles per gallon, the higher Vehicle Green Score 230. In some embodiments, Vehicle Green Score 230 may be calculated based on Vehicle Information 218, such as vehicle make-model-year and/or fuel consumption information etc. When considering hybrid/electric vehicle, miles per carbon emitted (at electric power station, etc) may represent Vehicle Green Score 230.

In some embodiments, a driver participant may pick up more than one passenger participants along a rideshare trip. For example, the driver participant may pick up one passenger participant first and then another passenger participant somewhere in between the origin and the destination. For such rideshare arrangements, one or more Trip Proposals 252 may be concatenated to other already scheduled trips. The feasibility of concatenating Trip Proposal 252 combined with Vehicle Green Score 230 and Travel Mode Preference 222 may be used to make recommendations of a participant as a driver participant using a vehicle for a rideshare trip. Such recommendation may then be recorded in Travel Mode Role Recommendation 258 and stored on Rideshare Platform 110.

Trip Interest 234 may be entered to indicate an interest in a rideshare trip. The interested trip information may be entered by the participants and received by Rideshare Platform 110. Such information may include desired vehicle, trip origin/pick up location, destination/drop-off location, and time constraints. Trip Interest 234 may also allow participants to indicate whether they are flexible around origin/pickup location, destination/drop-off location, and/or trip start time. Based on the information, for each Trip Interest 243, Ride Match module 250 may generate one or more Trip Proposals 252 and provide them to two or more participants if their Trip Interests 234 match.

In some embodiments, Trip Proposal 252 may be ranked based on score matrixes such as Social Interest Match Score 254, Personal Likeability Score 256, and Trip Experience Score 260, among others. Social Interest Match Score 254 may be derived from social network handle provided in a participant Bio-graphic Information 212. Personal Likeability Score 256 may be based on past rideshare experience of other participants who have shared a ride with a participant in the past. Trip Experience Score 260 may be based on performance of a participant in past rideshare trips. The one or more Trip Proposals 252 generated by Ride Match module 250 may be ranked and provided to a participant based on the overall ranking of Social Interest Match Score 254, Personal Likeability Score 256, and Trip Experience Score 260.

Trip Experience Score 260 may be further calculated based on Trip Completed 262, Trip Modification Initiated 264, Trip Modification Accommodated 266, Trip Cancelations 268, and Trip Disputes 270, among others. A trip may be considered successful for a given participant if that participant is able to complete the trip. Conversely, a trip may be considered unsuccessful or cancelled for a given participant if that participant is unable to complete the trip.

In some embodiments, Trip Completed 262 may be the proportion and/or the numbers of past successfully completed Scheduled Trips 280. Trip Modification Initiated 264 may be the proportion and/or numbers of past successfully completed Scheduled Trips 280 that involved modifications initiated by a participant. Trip Modification Accommodated 266 may be the proportion and/or numbers of past successfully completed Scheduled Trips 280 that involved modifications accommodated by a participant. Trip Cancellations 268 may be a proportion and/or numbers of past unsuccessfully completed Scheduled Trips 280, where the failure of the past trips completion was due to the fault of a participant. Trip Disputes 270 may be a proportion and/or numbers of past unsuccessfully completed Scheduled Trips 280, where no participants took fault of the trip incompletion.

For each Trip Interest 234, a participant may pick one Trip Proposal 252 from the one or more Trip Proposals 252 provided by Ride Match 250. Based on the participant's choice of Trip Proposal 252, the participant may negotiate Route Plan 274, Pickup/Drop-off location 276, Driver Role and Trip Vehicle 277 and Trip Start Window 278 with other participants associated with Trip Proposal 252. Such participants are among Trip Participant Set 273, which may include other participants associated with the selected Trip Proposal 252. In some embodiments, Trip Start Window 278 may be a negotiated trip start time and a time interval of predetermined and/or negotiated length containing said trip start time. If these negotiations are successful, the response from participants of Trip Proposal 252 may be used to generate Scheduled Trip 280 and form Contract 282. PCDs associated with the participants in Scheduled Trip 280 may be updated with Trip Participant Set 273, Route Plan 274, Pickup/Drop-off location 276, Driver Role and Trip Vehicle 277, and Trip Start Window 278. In some embodiments, such updates may be sent from Rideshare Platform 110 and received by PCDs through long range wireless communication.

In some embodiments, Scheduled Trip 280 may also include Trip Modification Module 275. Through Trip Modification Module 275, any of participants within Trip Participant Set 273 may request some modifications before the start of Trip Start Window 278. Communicating with Rideshare Platform 110 through PCD or some other methods, a request may be sent by a participant to modify some information stored in Scheduled Trip 280. The modification may include Route Plan 274, Pickup/Drop-off location 276, Driver Role and Trip Vehicle 277, Trip Start Window 278, Trip Participant Set 273 (for exclusion or inclusion of self or other participant) or Trip Termination 279. Upon receiving the modification request, Rideshare Platform 110 may communicate with other participants associated with Scheduled Trip 280. After considering the modification request, all participants of Schedule Trip 280 may agree to the request of modification. In some embodiments, the requested modification may be a cancellation of Scheduled Trip 280. Additional costs may be imposed on the participant, who requested the modification; and additional rewards may be given to other participants, who agree to accommodate the modification. If all participants of Schedule Trip 280 do not agree to the request of modification, the request may be declined, and the original Schedule Trip 280 parameters may stay in effect. In some embodiments, a trip modification request may instead go directly to trip participants within Trip Participant Set 273, and Rideshare Platform 110 may be notified of the result only.

For Scheduled Trip 280, Contract 282 may be formed. Terms such as Trip Cost Payment Terms 284 and Alternative Transportation Cost Payment Terms 286, among others, may be included in Contract 282. Trip Cost Payment Terms 284 may include payment terms for participants to agree to in case of various contract transactions. The payment terms may include agreeing to pay costs associated with a rideshare trip, pay penalties when a trip is cancelled, and/or compensation when accommodating other modifications requested by other participants etc.

For example, for a passenger participant, if a trip is successful, according to Trip Cost Payment Terms 284, the passenger participant agrees to pay his share of the trip cost. The amount may be calculated based on factors such as trip distance, actual fuel usage, number of participants in a trip, charge for accumulated trip modification requests initiated by the passenger participant offset by accumulated trip modification request accommodated by the passenger participant. In case of an unsuccessful trip due to the passenger participant's fault, according to Trip Cost Payments Terms 284, in addition to agreeing to pay his share of the trip cost, penalty may be charged to the passenger participant.

Similarly, according to Trip Cost Payment Terms 284, a driver participant may receive compensation. The amount of the compensation may be calculated based on factors such as trip distance, actual fuel usage, number of participants in a trip, adjusted by accumulated trip modification requests initiated by the driver participant, and offset by accumulated trip modification requests accommodated by the driver participant. Exchange of payment may occur between driver participant and passenger participant(s) and/or between each participant and Rideshare Platform 110.

Alternative Transportation Cost Payment Terms 286 may also be included as part of Contract 282. Alternative Transportation Cost Payment Terms 286 may be used to track the actual cost of alternative transportation arrangement when Scheduled Trip 280 is unsuccessful. For example, according to Alternative Transportation Cost Payment Terms 286, a driver participant may agree to pay driver penalty to each passenger participants in Scheduled Trip 280 if Scheduled Trip 280 is unsuccessful due to the driver participant's fault. The driver penalty may be distributed among passenger participants as compensation in order to cover the cost of alternative transportation arrangement. In some embodiments, alternative transportation cost may be a fixed amount. In some other embodiments, alternative transportation cost may be an amount based on Scheduled Trip 280 distance with or without maximum cap amount. Yet in some other embodiments, alternative transportation cost may be an amount based on the actual cost incurred by making alternative transportation with or without maximum cap amount. Rideshare Platform 110 may subsidies driver participant by sharing cost of alternative transportation. Exchange of payment may occur between driver participant and passenger participant(s) and/or between each participant and Rideshare Platform 110.

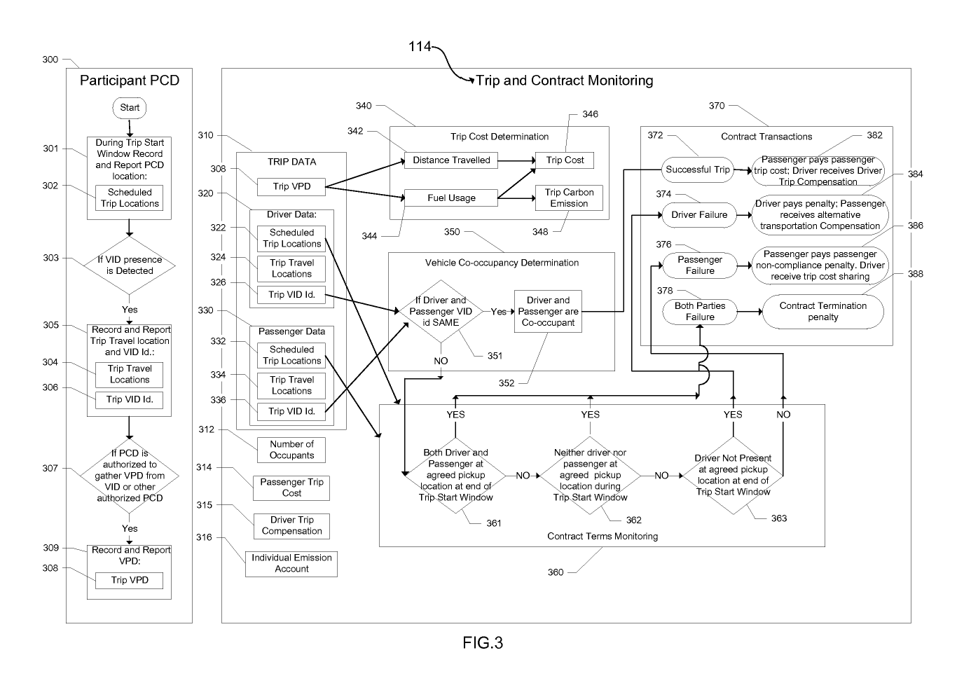

FIG. 3 illustrates the interaction between rideshare participants PCD and Trip and Contract Monitoring sub-system 114, in accordance with some embodiments.

In step 301, at the beginning of Trip Start Window 278, each participant PCD 300 may record and report PCD location as Scheduled Trip Location 302. The location determination may be made through PCD 300 communicating with GPS Satellites 172. In some embodiments, Scheduled Trip Location 302 may be continuously recorded till the earlier of the end of Trip Start Window 278 obtained from stored Scheduled Trip 280 or when VID presence is detected in step 303. Both begin and end time of Trip Start Window 278 may be recorded. At the end of actual Trip Start Window 278, a rideshare trip has started if valid VID is detected.

During the rideshare trip, Trip Travel Location 304 and VID Identifier 306 may be recorded in step 305. The recording may start from the time when VID presence is detected to the time when VID presence is no longer detected. Trip Travel Location 304 may be a time stamped data set associated with VID Identifier 306 and containing information such as location obtained from communication with GPS Satellites 172, begin-time of the rideshare trip, sampling interval and/or end-time of the rideshare trip etc.

The presence of VID may be detected through a search for VIDs using PCD 300 short range wireless communication. If VID presence is detected, PCD 300 may record Trip Travel Location 304 and record the identifier associated with the detected VID as VID identifier 306. In some embodiments, the detection for the presence of VID may be restricted to a set of VID's. The set of VID's may be among VID's associated with participants from Trip Participant Set 273, VID associated with the driver participant, and/or VID associated with trip vehicle from Driver Role and Trip Vehicle 277.

In step 307, a determination may be made if PCD 300 is authorized to request vehicle performance data (VPD) from the vehicle associated with the detected VID or other PCDs who have detected the same VID. Following step 307, if the authorization is successful, in step 309, VPD may be obtained and recorded in Trip VPD 308. VID may be set up to connect with only one PCD or more than one PCD to it simultaneously. In some embodiments, connection to VID may be with or without PCD authentication. By configuring VID to allow vehicle owner's PCD to connect, Rideshare Platform 110 may ensure that at least one participant's PCD from Trip Participant Set 273 is able to connect and obtain Trip VPD 308.

For example, a first Participant PCD 300 may record Scheduled Trip Locations 302, Trip Travel Location 304 and Trip VID Identifier 306. Based on the information from Scheduled Trip 280, the first Participant PCD 300 may be determined as being associated with a driver participant. As a result, the recorded Scheduled Trip Locations 302, Trip Travel Location 304 and Trip VID Identifier 306 by the first Participant PCD may become part of Driver Data 320, such as driver's Scheduled Trip Location 322, Trip Travel Location 324, and Trip VID Identifier 326. Similarly, a second Participant PCD 300 may record Scheduled Trip Locations 302, Trip Travel Location 304 and Trip VID Identifier 306. Based on the information from Scheduled Trip 280, the second Participant PCD 300 may be determined as being associated with a passenger participant. As a result, the recorded Scheduled Trip Locations 302, Trip Travel Location 304 and Trip VID Identifier 306 by the second Participant PCD may become part of Passenger Data 330, such as passenger's Scheduled Trip Location 332, Trip Travel Location 334, and Trip VID Identifier 336.

Among all participants in Scheduled Trip 280, in some embodiments, one participant may have a PCD that is authorized to connect and query vehicle for VPD as illustrated in step 307. Upon a successful authorization, VPD obtained by the authorized PCD may be reported to Rideshare Platform 110 as Trip VPD 308. In some other embodiments, when more than one authorized PCDs are present, Trip VPD 308 may be compiled from the average of data reported by multiple Participant PCDs 300. In some embodiments, connection to VID may be allowed without PCD authentication when communication is made with vehicle owner's PCD to connect. Such arrangement may be used to ensure that at least one participant's PCD from Trip Participant Set 273 is able to connect and obtain Trip VPD 308.

Trip VPD 308 may be recorded from the time when VID to PCD connection is established to the time when the identified VID is no longer present within the range of PCD detection. Trip VPD 308 may be time stamped data set containing information such as VPD, VID identifier, begin-time of a rideshare trip, sampling interval and/or end-time of a rideshare trip etc.

All data recording may be performed at interval and may be communicated to Rideshare Platform 110, Trip and Contract Monitoring sub-system 114 using long range communications interface on Participant PCD 300, as illustrated in FIG. 1. This communication may occur instantaneously or in burst. Since all communication with Rideshare Platform 110 is carried over Participant PCD 300, there may be no additional cost for transferring data or minimal additional cost, where cost is based on incremental additional amount of data.

Having obtained Trip VPD 308, Driver Data 320, and Passenger Data 330 as Trip Data 310, Trip and Contract Monitoring modules 114 may monitor the actual cost incurred during a rideshare trip and monitor the performance of contract. Trip and Contract Monitoring 114 sub-system may include Trip Cost Determination module 340, Vehicle Co-occupancy Determination module 350, Contract Terms Monitoring module 360, and Contract Transactions module 370, among others.

Trip Cost Determination module 340 may use Trip VPD 308 to compute Distance and Time Travelled 342, as well as Fuel Usage 344. Distance and Time Travelled 342 and Fuel Usage 344 may in turn be used to calculate Trip Cost 346. For example, Trip Cost 346 can be computed as 1) Fuel Usage 344 multiply by average fuel cost within trip participant's local area plus distance travelled multiply by per mile cost of similar leased vehicle; or 2) distance travelled times IRS (or any other tax authority) provided per mile cost for business expense. In some embodiments, driver's driving labor cost may be added if desired by adding additional cost computed as trip time multiply by average hourly labor cost published by government authorities or some third party institutions. If trip route incurs additional costs such as toll charges etc., the charges may be added to the trip cost. Similarly, if according to agreed contract terms, passenger participants agree to share driver participant's additional costs such as parking etc., that cost may be added to trip cost as well.

Similar to Trip Cost 346, Trip Carbon Emission 348 may also be determined based on trip Fuel Usage 344 along with other information such as fuel type and trip information from Trip VPD 308. Alternatively, trip carbon emission 348 may be determined based on Trip Travel Location 304 and rideshare vehicle mileage profile from Vehicle Information 218.

Vehicle Co-occupancy Determination module 350 may determine co-occupancy using Driver Data 320 and Passenger Data 330. Once participants are validated as co-occupants, Successful Trip 372 may be registered in Contract Transactions module 370. In some embodiments, driver Trip VID Identifier 326 and passenger Trip VID Identifier 336 may be compared along with the respective timestamps to determine co-occupancy. If driver Trip VID Identifier 326 matches passenger Trip VID Identifier 336, and the timestamps associated with the identifiers match, driver and passenger may be validated as co-occupants. Otherwise, in case of a negative match, driver and passenger may not be co-occupants. In some other embodiments, co-occupancy determination may be made when driver Trip Travel Locations 324 and passenger Trip Travel Location 334 are compared with Pickup/Drop-off Location 276 negotiated for Scheduled Trip 280.

For example, to be considered a valid co-occupancy, based on location determination of PCDs, Pickup/Drop-off Location 276 co-ordinates need to be within some range from at least one location co-ordinate in Trip Travel Locations 324 and 334; and the timestamps associated with Trip Travel Locations 324 and 334 need to be recorded at roughly the same time instance. A predetermined +/−factor may be applied to accommodate time synchronization and sampling instance misalignment. The predetermined +/−factor need to be less than or equal to sampling interval of Trip Travel Locations 324 and 334. In case sampling intervals for Trip Travel Locations 324 and 334 are significantly different, the larger sampling interval may be used.

Having determined the overall cost of the trip in Trip Cost Determination module 340 and confirmed the co-occupancy in Vehicle Co-occupancy Determination module 350, Number of Occupants 312, Passenger Trip Cost 314, Driver Trip Compensation 315, and Individual Emission Account 316 may be updated. For example, Number of Occupants 312 may get updated to reflect the confirmed co-occupancy in a rideshare trip. Participant Individual Emission Account 316 may be incremented by Trip Carbon Emission 348 divided by Number of Occupants 312.

In some embodiments, Passenger Trip Cost 314 may be determined as Trip Cost 346 divided by Number of Occupants 312 when there are two or more occupants. In some other embodiments, Passenger Trip Cost 314 may be simply half of Trip Cost 346. Yet, in some other embodiments, Passenger Trip Cost 314 may be a fix fraction of Trip Cost 346, where the fraction is based on some constant value or Number of Occupants 312. Similar to Passenger Trip Cost 314 calculation, Driver Trip Compensation 315 may be determined as the sum of Passenger Trip Cost 314 of all passengers in a scheduled trip adjusted for rideshare platform revenue (if any), in accordance with some embodiments. Alternatively, Driver Trip Compensation 315 may be an amount based on factors such as Distance Travelled 342, trip time, and/or Number of Occupants 312.

Based on Trip Cost Determination 340 and Vehicle Co-occupancy Determination 350, the actual cost of rideshare for participants may be determined using Contract Term Monitoring 360 and Contract Transactions 370. Following Vehicle Co-occupancy Determination 350, Contract Term Monitoring 360 may determine contract transactions on an unsuccessful trip.

After step 351 in Vehicle Co-occupancy Determination module 350 indicates driver and passenger are not co-occupants, in step 361, Scheduled Trip Locations 322 from Driver Data 320 and Scheduled Trip Location 332 from Passenger Data 330 may be compared with Scheduled Trip 280 pickup location of Pickup/Drop-off Location 276. If both parties were present at the end of Trip Start window 278, failure may be assigned to both parties; and Both Parties Failure 378 may be registered in Contract Transaction module 370. Similarly, in step 362, if a determination is made that neither driver nor passenger was present at pickup location during Trip Start Window 278, failure may be assigned to both parties; and Both Parties Failure 378 may be registered in Contract Transaction module 370. Otherwise, if at least one of the participants was present, in step 363, driver participant's presence may be checked. If driver participant was not present at pickup location at the end of Trip Start Window 278, Driver Failure event 374 may be registered in Contract Transaction Module 370. On the other hand, if driver participant was present, Passenger Failure 376 may be registered in Contract Transaction Module 370.

Based on the determination made in Contract Terms Monitoring 360 and the corresponding contract transactions registered in Contract Transaction Module 370, Contract Transaction Module 370 may further perform the registered transactions according Contract 282 terms. In step 382, following Successful Trip 372, passenger participant may pay Passenger Trip Cost 314, and Driver Participant may receive Driver Trip Compensation 315. In step 384, following Driver Failure 374, driver participant may pay driver penalty and passenger may receive alternative transportation cost payment as describe in Contract Term 286. In step 386, following Passenger Failure 376, passenger participant may pay Passenger Trip Cost 314 and additional penalty, and driver participant may receive Driver Trip Compensation 315. In step 386, following Both Parties Failure 378, Contract Termination Penalty 388 may be charged to both parties. Exchange of payment may occur between driver-participant and passenger-participant(s) or between each participant and Rideshare Platform 110.

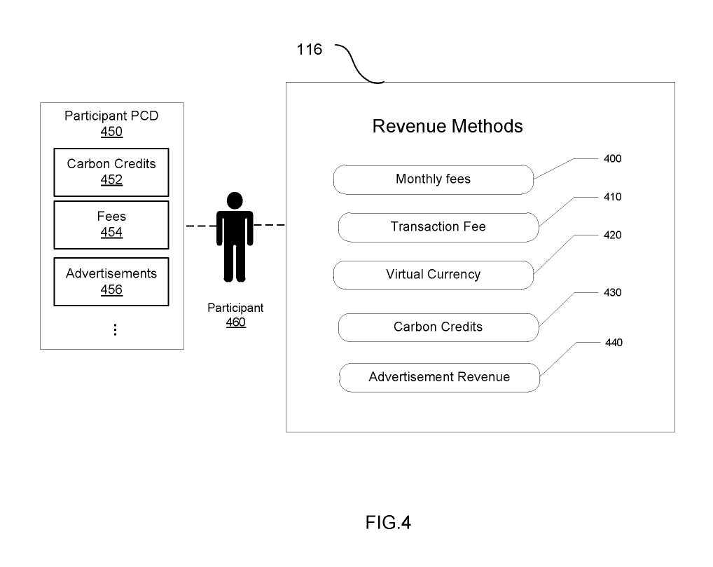

FIG. 4 illustrates various components within Revenue Methods 116 sub-system, in accordance with some embodiments. Revenue Methods 116 may include Monthly Fees 400, Transaction Fees 410, Virtual Currency 420, Carbon Credits 430, and Advertisement Revenue 440, among others. These components may help generate revenue for Rideshare Platform 110. Through Participant PCD 450, each Participant 460 may retrieve information such as Carbon Credits 452 allocated to Participant 460, Fees 454 needs to be paid, and Advertisements 456 tailored to Participant 460 etc.

In some embodiments, an advertisement module may allow Rideshare Platform 110 to generate Advertisement Revenue 440 by sending Advertisements 456 to rideshare Participant 460 at opportune time. Various opportune time may include Trip Start Window 158, the end of a successful rideshare trip etc. For example, Advertisements 456 may be sent to a passenger participant who is waiting for a driver participant to arrive during Trip Start Window 158. Advertisements 456 may also be sent to a driver participant when he is waiting for a passenger participant to arrive. In some embodiments, Advertisements 456 may also be sent to Participant 460 when Participant 460 is notified of scheduled trip modifications by Trip Modification Module 275 or when participants various accounts (Individual Emission Account 316, Carbon Credits 452, Fees 454 etc.) are updated.

Monthly Fees module 400 may track participants registered to Rideshare Platform 110 and charge predetermined monthly fees. In some embodiments, provision in contracts may be made to waive these monthly fees if greater than a predetermine number of rideshare trips are successfully taken by a participant over some period of time, or if greater than predetermine amount of carbon credit is generated by the participant over some period of time. In some other embodiments, a one-time registration fee may be charged. The effect of charging a one-time registration fee would be the same as charging predetermined monthly fees when in the monthly fee charging method, months fees are waived if greater than a predetermine number of rideshare trips are successfully taken after first month.

Transaction Fee module 410 may track rideshare Contract Transactions 370 among all participants in a rideshare system and derive revenues from assessing transaction fees based on a number of factors. For example, a fix predetermined amount may be accessed in some embodiments. Alternatively, a percentage of transaction amount among participants as fees may be accessed. The assessed amount may also be a combination of a fix predetermined amount and a percentage of transaction fees. Transaction Fee module 410 may also assess fees based on other transactions that participants make through Rideshare Platform 110. This may include, but not limited to, virtual currency conversion, vendor promotions, and/or carbon credit conversion.

Virtual Currency module 420 may allow Rideshare Platform 110 to float its own currency and enable participants to transact in rideshare platform currency. Participants may buy virtual currency using their own national currency to transact with other international participants. Other vendors may offer their promotions in terms of rideshare currency or allow conversion to and from between rideshare currency and their own reward points. For example, reward points may be airlines miles and/or credit card bonus points etc.

Rideshare Platform 110 through Carbon Credits module 430 may provide aggregation points for carbon emission reduction generated by all participants pooled together and generate carbon credit certificates. Any proceed from trading such carbon credits may be proportionally distributed between participants carbon emission reduction units pooled in the carbon credit. Rideshare Platform 110 may keep some predetermined fraction or all of such proceed to generate revenue for Rideshare Platform 110.

In regulatory regime where individual carbon emission is tracked and charged against individual carbon allowance, participant Individual Emission Account 316 may be used for allocating carbon emission for allocation against personal allowance. In addition, carbon emission reduction units may be used as a currency to transact with other participants in Rideshare Platform 110.

In some embodiments, Carbon Credits module 430 may compute carbon emission reduction (CER) units for each participant by aggregating Trip Carbon Emission 348 for every trip taken by the participant, allocating the aggregated amount to each participant, and subtracting from that participant's Individual Emission Account 316. Some adjustments may be made based on vehicle used in each trip from Driver Role and Trip Vehicle 277 versus participant's vehicle, trip's pickup/drop off location 276 versus participant's origin/final destination and whether the participant is a driver or a passenger.

In alternative embodiments, Carbon Credit module 430 may compute CER units for each participant in a rideshare trip using Trip Carbon Emission 348, rideshare vehicle mileage and rideshare participant alternate choice vehicle mileage. The alternate choice vehicle may be the vehicle that the participant would have used for their trip without rideshare, as described earlier in Vehicle Information 218. Vehicle mileage may be measured as distance travel per unit of fuel. Vehicle mileage information may be obtained from vehicle manufacturers. Alternatively, vehicle mileage information may be calculated using recent history of the vehicle's actual fuel consumption and distance travel data.

In some embodiments, fuel consumption by the rideshare vehicle and/or the alternative vehicle mileage information may be replaced by Vehicle Green Score 230 for computing CER units. As described previously referring to FIG. 2, Vehicle Green Score 230 is calculated based on Participant and Vehicle Registration 210 data and represents how efficient a vehicle is. Thus, similar to vehicle mileage, the more efficient a vehicle, the higher Vehicle Green Score 230. In cases when a vehicle is running on energy other than burning fuel, Vehicle Green Score 230 may be used in place of fuel consumption by the rideshare vehicle and/or the alternative vehicle mileage information for CER units computing. In some embodiments, Vehicle Green Score 230 may be calculated based on Vehicle Information 218, such as vehicle make-model-year and/or fuel consumption information etc. In some other embodiments, vehicle mileage information may be reduced to units of distance traveled per unit of carbon emission.

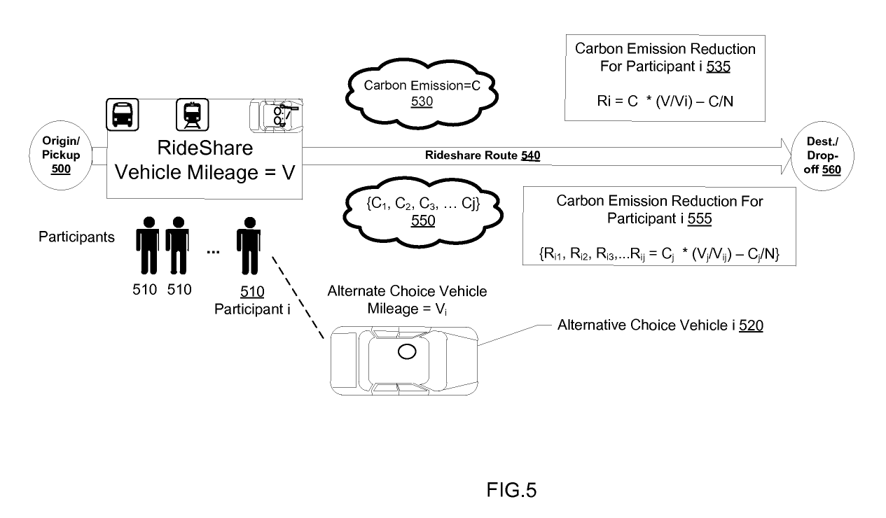

FIG. 5 illustrates the methods for computing carbon emission reduction during a rideshare trip in order to issue CER units, in accordance with some embodiments. Participants 510 may join a rideshare trip along Rideshare Route 540, starting from Origin/Pickup 500 and ending at Dest/Drop-off 560. As illustrated in FIG. 5, the rideshare vehicle may be applicable to any vehicle capable of transportation including, but not limited to, taxis, carpool vans, bus, subways, rails and vehicles travelling in air and/or water. During the rideshare trip, Carbon Emission amount 530 may be obtained. In some embodiments, Carbon Emission 530 data may be obtained from VPD. In some other embodiments, the information may be calculated based on trip data, such as speed etc. obtained from PCD and carbon emission information obtained from manufacturer for the rideshare vehicle.

The participant alternate choice vehicle's emission co-efficient relative to rideshare vehicle may be calculated as a ratio of rideshare vehicle mileage to that of an alternate choice vehicle. For example, using factors as follows:

C=carbon emission of the rideshare trip;

N=number of participants in the rideshare trip;

Vi=alternative choice vehicle mileage for participant i;

V=rideshare vehicle mileage.

A participant alternate choice vehicle's emission co-efficient relative to rideshare vehicle may be calculated as V/Vi. Using the co-efficient, Carbon Emission Reduction for Participant i 535 may be calculated by applying the following:

$$Ri = C \times \frac{V}{Vi} - \frac{C}{N} ;$$

$$Ri = Carbon emission reduction for participant i .$$

For a driver participant, since the vehicle driven during a rideshare trip is his alternative choice vehicle, alternate choice vehicle's emission co-efficient V/Vi is one. To collect more carbon emission reduction, he may prefer to have more passenger participants join a rideshare trip (the value of N increases). For a passenger participant, if his alternative choice vehicle is more efficient (the value of Vi is higher, alternative choice vehicle's emission co-efficient V/Vi is lower), i.e. an alternative choice vehicle with higher Vehicle Green Score 230 not used as a rideshare vehicle during a rideshare trip, the less carbon emission reduction credit may be generated for him.

In some embodiments, more accurate carbon emission reduction estimate may be obtained by calculating a series of carbon emission reduction and summing the series. The series may be divided around segments of a rideshare trip based on vehicle speed or driving conditions during a rideshare trip. During each segment of the rideshare trip, vehicle speed or driving condition may be different. Since vehicles mileage may be different under different speed or driving condition, an alternative choice vehicle i's emission co-efficient Vj/Vij may be calculated for each of the jth segment of the rideshare trip. The carbon emission reduction of each segment may be calculated based on that segment's alternative choice vehicle's emission co-efficient Vj/Vij and carbon emission of rideshare vehicle during that segment Cj. Summing carbon emission reduction per speed or driving condition in the series may result in more accurate carbon emission reduction estimate.

For example, a series of segments of a rideshare trip may be divided based on driving conditions such as heavy or light traffic, constructions etc., or vehicle speed such as on highway or local etc. During each segment, carbon emission information may be obtained. In some embodiments, the information may be obtained from VPD. In some other embodiments, the information may be calculated based on trip data, such as speed etc. obtained from PCD and carbon emission information under a trip condition, such as carbon emission information under city or highway driving condition etc. The carbon emission information under different trip condition may be obtained from manufacturers. The series of Carbon Emission 550 for the rideshare trip may be as follows:
{C₁, C₂, C₃, . . . Cj}; Cj=carbon emission during segment j of the rideshare trip.

For Participant i 510 with Alternative Choice Vehicle i 520, Alternative Choice Vehicle i 520 emission co-efficient for each segment of the rideshare trip may be as follow:
{V₁/Vᵢ₁, V₂/Vᵢ₂, V₃/Vᵢ₃, . . . Vj/Vij}; Vij=vehicle i as an alternative choice vehicle mileage during segment j; Vj=rideshare vehicle mileage during segment j.

Applying the same algorithm, the carbon emission reduction for each segment may be as follows:

$$Rij = Cj \times \frac{Vj}{Vij} - \frac{Cj}{N} ;$$

$$Rij = Carbon emission reduction during segment j for$$

$$participant i .$$

Carbon Emission Reduction for Participant i 555 may then be calculated by summing carbon emission reduction in the series as follows:

$$Ri = {\sum }_{j = 1}^{n} ( Cj \times \frac{Vj}{Vj} - \frac{Cj}{N} ) ;$$

$$n = number of segments in the rideshare trip ;$$

$$N = number of participants in the rideshare trip .$$

Having a rideshare system in accordance with some embodiments described herein has several benefits. First, with a contractual agreement component built in the system, the system is fair and transparent for calculating the actual cost of rideshare. Knowing the actual cost instead of an inaccurate upfront cost estimate, the system provides strong incentives to all parties when they honor their commitments to the contract. And to provide flexibility, the contract has fair and transparent terms for penalties and/or compensations, so that in case of a breach, the non-fault participant may be fairly compensated. Thus, relative to conventional rideshare methods and systems, which use presumed upfront cost estimate, the present invention is more likely to draw in or retain participants.

Second, the present invention has the benefit of utilizing affordable technologies and devices for automated contract performance monitoring including co-occupancy determination. Examples of such technologies and devices may be Bluetooth-OBD-II or similar devices such as WiFi-OBD-II devices and/or widely available personal communication devices, i.e. mobile phones with 3G/4G/LTE technology etc. The affordability may provide further incentive to draw in or retain rideshare participants.

Third, using affordable technologies and devices, the present invention has the benefit of providing highly accurate measurement of carbon emission. The accurate measurement of carbon emission may further allow an accurate and fair carbon emission reduction calculation for each rideshare participant. With effective measurement of carbon emission reduction, the present invention may generate more social and environmental benefits than conventional rideshare methods and systems.

Fourth, the present invention has the flexibility of being adapted to rideshare in any transportation system. For example, the highly accurate and efficient carbon emission measurements may be conducted even for vehicles not running on fuel energy. And the highly accurate and fair carbon emission credit allocation uses co-efficiency of the alternate choice vehicle's emission relative to that of the rideshare vehicle. The ratio may be calculated based on information obtained through PCD with or without interfacing with the rideshare vehicle. Thus, even without a specialized device, such as a dedicated device coupled with the rideshare vehicle, trip information and co-occupancy information may still be obtained through PCD, and the highly accurate and efficient carbon emission reduction calculation may still be conducted. This allows for the present invention to be adapted to rideshare in any transportation system for greater social and environmental benefits.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The present embodiments are to be considered as illustrative and not restrictive, and the invention is not to be limited to the details given herein. It is therefore intended that the disclosure and following claims be interpreted as covering all such alterations and modifications as fall within the true spirit and scope of the invention.

What is claimed is:

1. A method of a rideshare comprising:
receiving at least one participant data, at least one vehicle data, and at least one trip interest, wherein each of the one participant data comprises a personal communication device identifier associated with a personal communication device;
forming a contract for a rideshare trip among participants;
monitoring from a rideshare platform a performance of the rideshare trip;
based on the performance, calculating costs associated with the rideshare trip and determining contract transactions according to the contract; and
performing the contract transactions.

2. The method as recited in claim 1, further comprising:
deriving revenues from the contract transactions, wherein the revenues includes at least one carbon credit, an advertisement revenue, monthly fees, and fees derived from the contract transactions in forms of, but not limited to, at least one national currency, and at least one virtual currency; and
allocating the at least one carbon credit among the participants.

3. The method as recited in claim 1, wherein forming a contract for a rideshare trip among participants comprises:
wherein each of the at least one participant data comprises a bio-graphic information, and the personal communication device identifier, and a travel mode preference;
generating at least one rideshare trip proposal based on matches among the at least one trip interest;
based on the at least one vehicle data, calculating vehicle green scores;
ranking the at least one rideshare trip proposal based on social interest scores derived from the bio-graphic information, personality likability scores derived from at least one past rideshare experience, trip experience scores derived from at least one performance of at least one past rideshare trip, and travel model role recommendations, wherein the travel mode role recommendations are made based on the vehicle green scores and the travel mode preference;
providing the at least one rideshare trip proposal to the participants according to the ranking; and
based on responses from the participants, scheduling the rideshare trip and forming the contract for the rideshare trip among the participants.

4. The method as recited in claim 3, wherein scheduling the rideshare trip among the participants comprises:
wherein the rideshare trip is associated with the participants, a route plan, a pickup location, a drop off location, a driver role, a rideshare trip vehicle, and a rideshare trip start window;
prior to the performance of the rideshare trip, sending one or more modification requests of the rideshare trip submitted by one or more participants within the participants;
obtaining responses from the participants regarding the one or more modification requests;
based on the responses, determining the contract transactions according to the contract; and
performing the contract transactions.

5. A method of allocating carbon credits in a rideshare comprising:
during a rideshare trip, obtaining trip data through at least one personal communication device;
calculating a carbon emission reduction based on a trip carbon emission obtained from the trip data, at least one participant data, and at least one vehicle data associated with participants;
applying the carbon emission reduction to individual emission accounts associated with the participants; and
generating the carbon credits.

6. The method as recited in claim 5, wherein obtaining trip data through at least one personal communication device includes querying a vehicle to obtain the trip data through the at least one personal communication device.

7. The method as recited in claim 5, wherein calculating a carbon emission reduction based on a trip carbon emission obtained from the trip data, at least one participant data, and at least one vehicle data associated with participants comprises:
obtaining at least one emission co-efficient from the at least one vehicle data; and
calculating the carbon emission reduction for each of the participants based on the at least one emission co-efficient, the trip carbon emission, and the number of the occupants in the rideshare trip.

8. The method as recited in claim 7, wherein the at least one emission co-efficient includes a plurality of emission co-efficients, wherein the carbon emission includes a pluralities of carbon emissions corresponding to the series of emission co-efficients.

9. The method as recited in claim 1, wherein each of the at least one vehicle data comprises a vehicle information associated with a vehicle and a vehicle interface device identifier, wherein the vehicle interface device identifier is associated with a vehicle interface device coupled with the vehicle.

10. The method as recited in claim 9, further comprising:
during the rideshare trip, querying the vehicle to obtain a carbon emission through the personal communication device and the vehicle interface device;
calculating a carbon emission reduction based on the carbon emission, the at least one participant data, and the at least one vehicle data;
applying the carbon emission reduction to individual emission accounts associated with the participants; and
generating carbon credits.

11. The method as recited in claim 1, wherein monitoring from the rideshare platform a performance of the rideshare trip comprises:
prior to the rideshare trip, authenticating the participants through the personal communication device; and
based on a positive authentication, during the rideshare trip, through the personal communication device, obtaining trip data, communicating the trip data to the rideshare platform, and determining a number of occupants.

12. The method as recited in claim 11, wherein based on the performance, calculating costs associated with the rideshare trip and determining contract transactions according to the contract comprises:
determining the costs based on the trip data, wherein the costs includes a distance travelled, a fuel usage, a trip cost, and a trip carbon emission;
calculating at least one passenger trip cost and at least one driver trip compensation based on the cost and the number of occupants;
determining a vehicle co-occupancy information based on the trip data;
based on the determination that a driver and a passenger are co-occupants, registering a successful trip contract transaction;
based on the determination that a driver and a passenger are not co-occupants, determining if both the driver and the passenger were present at a beginning of the rideshare trip;
if both the driver and the passenger were present at the beginning of the rideshare trip, registering a both parties failure contract transaction;
if both the driver and the passenger were not present at the beginning of the rideshare trip, registering a both parties failure contract transaction;
if the driver was not present at the beginning of the rideshare trip, registering a driver failure contract transaction; and
otherwise, registering a passenger failure contract transaction.

13. The method as recited in claim 1, wherein performing the contract transactions comprises:
wherein the contract includes trip cost payment terms and alternative transportation cost payment terms in case of a plurality of contract transactions;
for each of the contract transactions, according to the contract, determining for a contract transaction the trip cost payment terms and the alternative transportation cost payment terms to apply;
if the contract transaction is a successful trip contract transaction, having a passenger pay a passenger trip cost and giving a driver a driver trip compensation;
if the contract transaction is a both parties failure transaction, applying a contract termination penalty to both the driver and the passenger;
if the contract transaction is a driver failure transaction, having the driver pay a driver penalty and giving the passenger an alternative transportation cost payment; and
otherwise the contract transaction is a passenger failure transaction, having the passenger pay the passenger trip cost and an additional penalty and giving the driver the driver trip compensation.

14. The method as recited in claim 2, wherein the advertisement revenue includes a revenue obtained by sending at least one advertisement to the participants at an opportune time.

15. The method as recited in claim 14, wherein the sending includes sending to the personal communication device.

16. A system for a rideshare comprising:
at least one personal communication device capable of communications and location determination provided to at least one participant during the rideshare; and
a rideshare platform containing
a participant ride matching and contract module for receiving at least one participant data, at least one vehicle data, and at least one trip interest,
revenue methods for deriving revenues and allocating carbon credits among the participants, and
a communication network interface coupled to the rideshare platform for sending and receiving communications over a communication network with the at least one personal communication device.

17. The system of claim 16, wherein allocating carbon credits comprises:
during a rideshare trip, obtaining trip data through the at least one personal communication device;
calculating a carbon emission reduction based on a trip carbon emission obtained from the trip data, the at least one participant data, and the at least one vehicle data associated with participants;
applying the carbon emission reduction to individual emission accounts associated with the participants; and
generating the carbon credits.

18. The system of claim 17, further comprising:
at least one vehicle interface device coupled with a rideshare vehicle capable of communicating with the last least one personal communication device, wherein each of the at least one vehicle interface device is identified by a vehicle interface identifier, wherein obtaining trip data through the at least one personal communication device includes querying the rideshare vehicle to obtain the trip data through the at least one personal communication device.

19. The system of claim 16, wherein the rideshare platform comprises:
the participant ride matching and contract module for receiving the at least one participant data, the at least one vehicle data, and the at least one trip interest and forming a contract for a rideshare trip among the participants, wherein each of the at least one participant data comprises a personal communication device identifier associated with a personal communication device of the at least one personal communication device, wherein each of the at least one vehicle data comprises a vehicle information associated with a vehicle,
the trip and contract monitoring module for monitoring from the rideshare platform a performance of the rideshare trip, based on the performance, calculating costs associated with the rideshare trip, determining contract transactions according to the contract, and performing the contract transactions,
the revenue methods for deriving revenues from the contract transactions and allocating carbon credits among the participants, and
the communication network interface coupled to the rideshare platform for sending and receiving communications over a communication network with the at least one personal communication device.

20. The system of claim 16, wherein the revenues includes at least one carbon credit, an advertisement revenue, monthly fees, and fees derived from the contract transactions in forms of, but not limited to, at least one national currency, and at least one virtual currency,
wherein the advertisement revenue includes revenues obtained by sending at least one advertisement to the participants at an opportune time, wherein the at least one advertisement is received by the at least one personal communication device over the communication network.
